(19) United States
(12) Patent Application Publication
(10) Pub. No.: US 2003/0231678 A1
(43) Pub. Date: Dec. 18, 2003

(54) Laser flashlamp life extension driver

(76) Inventor: Martin Stuart, Lakeview Terrace, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/458,509

(22) Filed: Jun. 9, 2003

Related U.S. Application Data
(60) Provisional application No. 60/386,882, filed on Jun. 7, 2002.

(51) Int. Cl. H01S 3/00; H01S 3/091; H01S 3/092

(52) U.S. Cl. 372/38.06; 372/70

(57) ABSTRACT

A method and apparatus for operating a flashlamp laser by powering the flashlamp during a series of discrete pulses during an arbitrary time window provides a flashlamp having an extended lifetime. The arbitrary time window may be a time window during which a flashlamp would be continuously pulsed in conventional operation. The laser provides lasing action continuously during a time window during which the associated flashlamp is powered for only portions of the time window. The resulting lowered coulomb transfer rate per pulse and time window utilized produce an extended flashlamp lifetime.

### RELATED APPLICATIONS

This application claims priority of U.S. Provisional Application No. 60/386,882 filed Jun. 7, 2002.

### FIELD OF THE INVENTION

The present invention relates to an apparatus and method for controlling and driving a flashlamp laser to provide an extended laser lifetime.

### BACKGROUND OF THE INVENTION

Flashlamp powered lasers serve various commercial purposes such as jewelry repair and welding, heat treatment of jewelry, and the repair and assembly of various electrical components. A flashlamp works on the principle whereby electrical power is delivered to a lamp which converts that energy into light energy, or photons. In the flashlamp laser, the light energy or photons are then absorbed in a laser rod which stores the light energy or photons in the crystal structure of the laser rod itself. The laser rod is formed of a material which fluoresces and includes mirrors at opposed ends to bring about the lasing action. The laser beam provided by the laser rod is then transmitted by an optical transmission medium, such as an optical fiber, to the point of use such as the sample or the stage upon which a sample is mounted. The sample may be jewelry or other micro-components which are being assembled or repaired by the laser. Flashlamp powered lasers find application, for example, in dental repair, gun repair, and the assembly and repair of medical instruments and various other microelectronic components.

The lifetime of a flashlamp varies inversely with the coulomb transfer per pulse. Flashlamp lasers are conventionally operated by simply turning the lamp on and off as desired. Conventional flashlamp lasers are typically operated using a relatively long pulse time of about 1 to 20 milliseconds and the flashlamps to provide 20-40 output joules per pulse, at the point of operation. According to conventional methods, power is continuously supplied to the flashlamps in the form of current during the entire time segment the flashlamp laser is being operated. Operating in this mode, the coulomb transfer has typically been a relatively high 2 to 6 coulombs per pulse in small laser welders, for example. Such a coulomb transfer rate is required to provide a sufficiently high laser output power required in most applications while operating using conventional methods. This magnitude of coulomb transfer per pulse typically provides a lifetime of 10,000-500,000 pulses per flashlamp. FIG. 1 is an exemplary graph showing the correlation between lifetime in number of pulses, versus charge in coulombs per pulse, for an exemplary 700 torr Krypton flashlamp in the 5-8 mm bore diameter range used in industrial Nd:YAG lasers. FIG. 1 clearly illustrates the dramatic increase in flashlamp lifetime corresponding to a reduced coulomb transfer per pulse for the exemplary flashlamp and is typical of the correlation between flashlamp lifetime and coulomb transfer for various other flashlamp lasers.

It would clearly be desirable to extend the lifetime of a flashlamp laser to save the considerable materials and labor costs associated with replacing the laser.

### SUMMARY OF THE INVENTION

The present invention provides a method and apparatus for operating a flashlamp laser to achieve an extended lifetime. The present invention uses a lower coulomb transfer rate while providing a laser output power that is sufficiently high for most applications such as laser welding.

In one embodiment, the present invention provides a method for operating a flashlamp laser. The method includes providing a flashlamp laser including a laser and a flashlamp and causing the laser to continuously provide a laser beam during a time period, while powering the flashlamp only during portions of the time period. The flashlamp may be powered by a succession of pulses during the time period.

In another exemplary embodiment, the invention provides an apparatus including a flashlamp laser including a laser and flashlamp, a microprocessor, and a laser driver. Together, the laser driver and microprocessor of the apparatus are capable of causing the laser to continuously provide a laser beam during a time period during which the laser is powered for only a portion thereof.

### BRIEF DESCRIPTION OF THE DRAWING

The present invention is best understood from the following detailed description when read in conjunction with the accompanying drawing. Included in the drawing are the following figures.

FIG. 1 is a graph showing an exemplary correlation between flashlamp lifetime versus charge in coulombs per pulse;

FIG. 2 is a sample discharge table for laser lamp life extension according to the present invention;

FIGS. 3A-3C show the fluorescence of a laser rod in response to current applied to a flashlamp, according to the present invention: FIG. 3A shows current delivered to the flashlamp; FIG. 3B shows light out of the flashlamp; and FIG. 3C shows rod fluorescence;

FIG. 4A is a timing diagram showing an exemplary flashlamp powered for 45 microseconds per 200 microsecond window;

FIG. 4B is a timing diagram showing the flashlamp powered for different time periods during the 200 microsecond window;

FIG. 4C is a timing diagram showing how the laser can be powered differently to perform different operations; and

FIG. 5 is a circuit diagram showing an exemplary flashlamp laser system according to the present invention.

### DETAILED DESCRIPTION OF THE INVENTION

The present invention is directed to flashlamp powered lasers that serve various commercial purposes such as jewelry repair and welding, heat treatment of jewelry, and the repair and assembly of various electrical micro-components. The flashlamps of the present invention convert the electrical power delivered to the lamp into light energy, or photons. The light energy or photons are absorbed in a laser rod which stores the light energy or photons in the crystal structure of the laser rod itself. The laser rod is formed of a material which fluoresces and typically includes mirrors at opposed ends to bring about the lasing action. In an exemplary embodiment, the laser rod may be formed of Nd:YAG, but other materials may be used in other exemplary embodiments. The laser beam provided by the laser rod may be transmitted by an optical transmission medium, such as an optical fiber, to the point of use such as the sample or the stage upon which a sample is mounted. The laser beam may be used to perform various operations on the sample. The present invention also finds application, for example, in dental repair, gun repair, and the assembly and repair of medical instruments and various other electronic and microelectronic components.

The present invention provides a microprocessor and laser driver that form an apparatus and provide a method for operating and controlling a flashlamp laser. The microprocessor and laser driver control the flashlamp laser by taking a time frame during which a conventional flashlamp laser would be turned on continuously, e.g.—a 20 millisecond portion of a one second window during which power is continuously provided to the flashlamp when operating according to conventional methods. The present invention then utilizes a plurality of discrete pulses during such a time frame that are sufficient to power the laser at a power level necessary to perform the requisite laser operations (e.g.—drilling, welding, heat treatment, etc.) and providing a lower duty cycle and lower coulomb transfer per pulse such that the lifetime of the laser is increased by orders of magnitude. A “pulse” is a brief time period during which power is provided to the flashlamp. When the flashlamp is not being pulsed during other portions of the time frame, no power is supplied to the flashlamp, yet the laser continues to provide lasing action. Stated alternatively, an aspect of the present invention is that the laser produces a laser beam continuously during a time period in which power is only intermittently provided to the associated flashlamp in the form of discrete pulses.

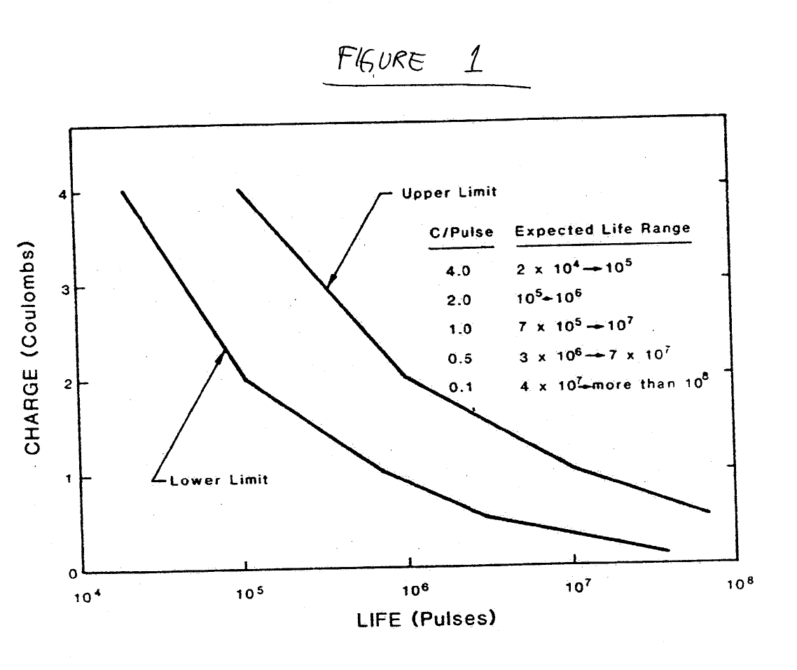

This is enabled by the discovery that, once a flashlamp reaches a stabilized plasma level, it stabilizes to a very predictable behavior that models a resistor and Ohm's law therefore applies. The present invention utilizes Ohm's law and the known fluorescent decay times of various crystal laser rods to control the laser. Since coulomb transfer per pulse determines laser life (see FIG. 1) and varies directly with current, and since the available electrical power of the system varies with the square of the current, the present invention utilizes an increased capacitor bank voltage to produce an increased current through the lamp functioning as a resistor. The increased current significantly lowers the duty cycle and increases the available electrical power of the system since such power varies with the square of the current. As such, a significantly reduced pulse time is needed to deliver the desired power. This reduced pulse time lowers the coulomb transfer per pulse which is a product of the current at first order, and the pulse time. The reduced coulomb transfer per pulse enables a significantly longer laser lifetime as shown in FIG. 1.

In contrast, conventional flashlamp lasers operate by simply turning the lamp on and off as desired and are typically operated using a relatively long pulse time of about 1 to 20 milliseconds and to provide 20-40 output joules per pulse, at the point of operation. Power is continuously supplied to the flashlamp in the form of current during the entire time segment the a flashlamp laser is being operated conventionally. An exemplary embodiment of a conventional flashlamp laser may be a krypton flashlamp with a 4 mm bore, a 15 cm arc length, 700 torr fill and having an impedance/resistance of 1.1666 ohms during discharge. According to conventional operation, a 350 volt electrolytic capacitor bank produces a 300 amp current discharge according to Ohm's law (350V/1.1666 ohms), which also provides a 105 kW per second energy transfer rate (300 amp²×1.166 ohms) with a pulse duration of 0.5 to 20 milliseconds. In this case, the coulomb transfer per pulse may be as high as 6 when the pulse duration is 20 milliseconds. FIG. 1 covers a 700 torr krypton flashlamp in the 5-8 mm bore diameter range commonly used in industrial Nd:YAG lasers and illustrates that a coulomb transfer in this range predicts a lifetime of about 10,000 pulses of 20 millisecond duration. Such is exemplary only and other similar conventional systems have lifetimes within the 10,000-500,000 pulse range, according to the various Charge (coulombs)/Life (pulses) graphs characteristic for the various flashlamp embodiments, such as the exemplary correlation graph of FIG. 1.

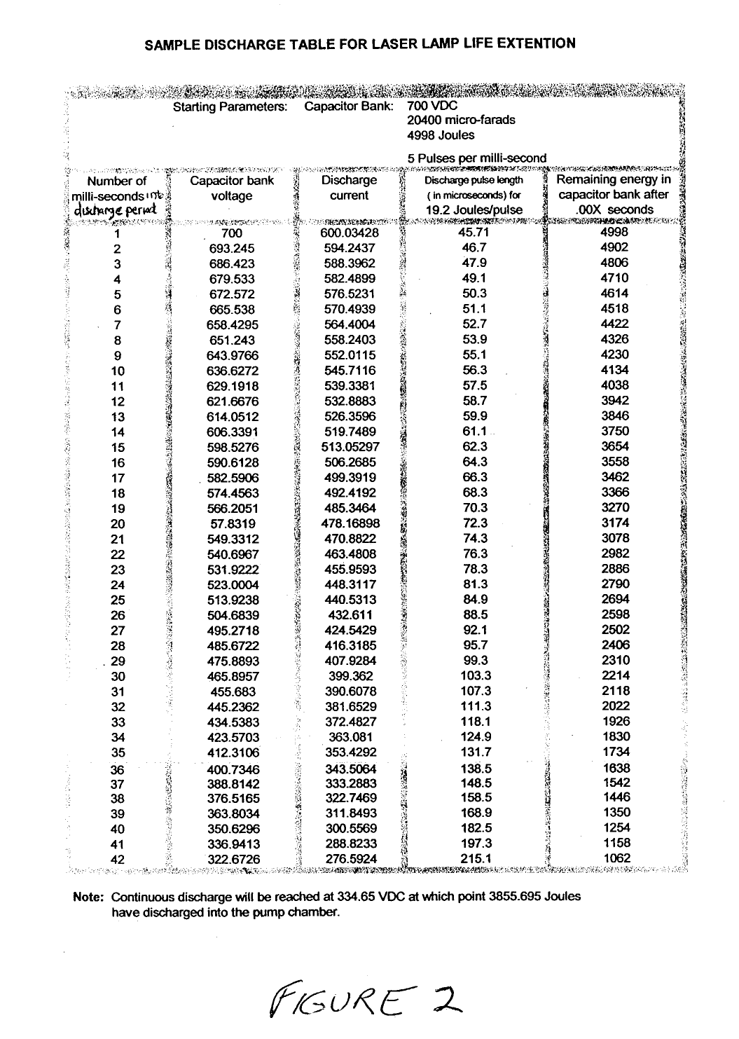

According to an exemplary embodiment, the present invention considers the fluorescence decay time, the necessary power to be delivered, and the need for a lowered coulomb transfer per pulse, and utilizes the microprocessor and driver to design an arbitrary envelope of time, for example 20 milliseconds, 40 milliseconds, etc., and divide this into a number of separate pulse periods during the envelope, to take advantage of the fluorescence decay time and to deliver a sufficient power out of the laser and to the specimens. The flashlamp laser may thereby be powered for a brief time period but the laser rod continues to fluoresce after this brief time period, continuing to provide lasing action. For example, the laser may be controlled such that each millisecond of a 20 millisecond envelope is divided into 5-200 microsecond windows. In one embodiment, after the 20 millisecond time envelope elapses, the capacitor may be recharged during the remainder of the first second, until the next 20 millisecond envelope begins at the start of second number two. The microprocessor calculates and the driver drives the laser, based on system power required and takes into account the energy drain of the capacitor bank during usage, to provide a substantially equal amount of energy to the lamp during each exemplary millisecond throughout the arbitrary 20 millisecond time envelope. During each arbitrary 200 millisecond time envelope, an equal amount of energy may be provided by using five equal pulses during each 200 microsecond window for each of the 20 milliseconds. For each successive millisecond during the defined time envelope, the time on (pulse time) during each of the five 200 microsecond windows, increases to account for the power loss due to the voltage drop across the discharging capacitor bank and therefore the reduced current through the lamp acting as a resistor. The microprocessor takes into account the energy drain and compensates by increasing the time the laser must be on during each 200 microsecond window, to provide the same power during each millisecond within the arbitrary 20 millisecond time envelope. This technique is shown numerically in the table of FIG. 2.

The present invention provides a method and apparatus that may be used to drive any of various and conventional flashlamp lasers, using a microprocessor controlled driver to provide a sufficient amount of energy to power the laser to perform functions such as drilling, welding and heat treating, while significantly reducing the coulomb transfer rate (coulomb transfer per discrete pulse) and extending the lifetime of the flashlamp by several orders of magnitude, compared to the above conventional method of operation. The driver apparatus may consist of a microprocessor and an IGBT, insulated gate bipolar transistor with a driver board that drives and controls the flashlamp and laser.

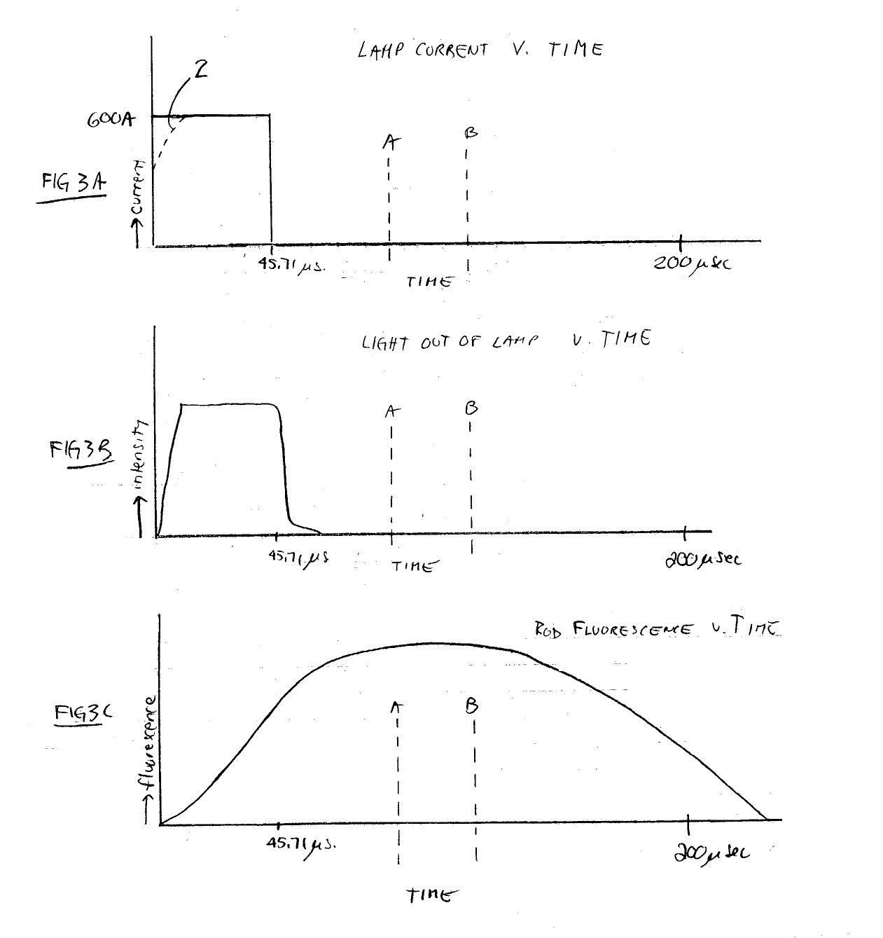

Flashlamps filled with various materials such as krypton, argon, xenon, and other suitable and conventional materials, stabilize to a very predictable behavior that models a resistor, once the flashlamp reaches a stabilized plasma level. With the flashlamp behaving essentially as a resistor, the design and operation of the flashlamp laser may be carried out in accordance with Ohm's law, which describes important aspects of resistors. Another fundamental consideration of the present invention is the fluorescence decay time of the laser rod. A laser rod continues to fluoresce and produce lasing action after the lamp used to provide photons to the rod, ceases to be powered. The actual fluorescence decay time is an inherent material characteristic of the rod material. According to the present invention, the microprocessor and driver operate the laser using a succession of discrete pulses such that, during a typical envelope of operation during which a conventional laser would be continuously powered, the apparatus of the present invention pulses the lamp “on” and “off” using discrete segments within the envelope and utilizes the fact that the rod continues to fluoresce after the discrete “on” (pulse) segment is completed, to provide a sufficient lasing power. This will be shown in FIGS. 3A-3C. The system of the present invention utilizes Ohm's law to provide the necessary power to the lamp to ensure lasing action, and at coulomb transfer per pulse that is also governed by Ohm's law. The microprocessor/driver operates the laser at a lower duty cycle such that input energy is not wasted, the coulomb transfer per pulse is reduced, and the lifetime of the flashlamp is increased. This enables the surface heating of the electrode to diffuse into the body of the electrode and reduces the sputter evaporation of electrode material.

According to an exemplary embodiment for operating a laser according to the present invention, the laser output power required to perform the desired laser functions is first determined. In an exemplary embodiment, the laser function may be laser welding. Since the flashlamp acts as a resistor, the present invention takes advantage of the fact that energy varies as the square of the current while coulomb transfer varies as the current. Using these principles, then, a significantly higher capacitor bank voltage may be used. Conventional arrangements may use capacitor bank voltages within the range of 300-350 volts. In an exemplary embodiment, however, the present invention may utilize a 700 volt capacitor bank to provide a reduced coulomb transfer per pulse and at a reduced duty cycle. Other capacitor bank voltages may be used in other exemplary embodiments.

In one exemplary embodiment, the microprocessor/driver of the present invention control the flashlamp laser to operate according to the sample discharge table for laser lamp life extension as in FIG. 2. FIG. 2 covers the exemplary embodiment of a 4 mm bore, 15 cm arc length, 700 torr krypton flashlamp using an Nd:YAG laser. Such is intended to be exemplary only and the principles of this invention can similarly be applied to Nd:YAG lasers of other dimensions and having other characteristics, as well as various other flashlamp laser types. For example, the flashlamps may be filled with xenon, krypton, argon, or the like, and the laser rod may be formed of vanadate (yttrium orthovanadate) or alumina, or other materials in other exemplary embodiments.

In this exemplary embodiment using the above-described Nd:YAG laser and a 700 volt capacitor bank voltage having an impedance/resistance of 1.166 ohms when acting as a resistor, this provides a current of 600 amps and the system is therefore capable of delivering 420 kW of power. In this exemplary embodiment, a four-fold increase in the capability of the electrical system to deliver power is achieved, in comparison to a 350 volt capacitor bank. This lowers the duty cycle by 75%. This increased power capability therefore decreases the amount of time needed to deliver such power which, in turn, reduces the coulomb transfer per pulse.

Based upon the inherent maximum energy storage capacity of the rod and the operable conversion efficiency, in an exemplary embodiment, 96 joules per millisecond of energy per pulse must be transferred to the laser rod, in order to power the laser to operate as desired. Flashlamp powered lasers have a conversion efficiency that may range from 3.5 to 20 percent; and commonly within the 6.6 to 10 percent range. With 96 joules/millisecond provided to the laser rod, this produces a laser output power of about 6 to 10 joules/millisecond. When used in a succession of 20 millisecond time frames, such laser energy output is suitable for the welding of metal such as jewelry or metal microcomponents.

The present invention, according to the table of FIG. 2, designs an operating scheme that arbitrarily utilizes 5 pulses per millisecond, or a pulse time window of 200 microseconds to produce such power. Other time windows may be used in other embodiments. During each pulse, it is therefore necessary to provide (96/5) 19.2 joules. The capability of the electrical system to deliver power is determined by Ohm's law, I²R. In this case (600 amps)²×1.166 ohms=420,000 watts. Dividing 19.2 joules by 420 kW (J/S), a pulse duration of 0.000045 seconds or 45 microseconds is attained as necessary to deliver the required power. As such, an initial pulse period of 45 microseconds per 200 microsecond window is used for each of the five-200 microsecond windows during the first millisecond of operation. As the number of milliseconds into the discharge increases, the capacitor bank voltage decreases and the corresponding discharge current (voltage/1.166 ohms) decreases accordingly. The discharge pulse length in microseconds therefore increases within the 200 microsecond window as the lamp must be powered for a longer time period within the 200 microsecond window to produce 19.2 joules. This is shown in the table of FIG. 2, which also indicates that the remaining energy in the capacitor bank decreases by 96 joules per each millisecond of discharge.

As energy is drained from the capacitor bank on each pulse, the voltage drops following an RC discharge curve associated with the laser. The microprocessor of the driver of the present invention, takes this into account and, along with the driver, turns the lamp on for a longer pulse period following the previous shorter pulse period. At the same time, a constant energy transfer rate per millisecond is maintained in order to drive the gain medium at optimum rates. For example, during the fifth millisecond, the flashlamp is pulsed for 50.3 microseconds during each of the five equal 200 microsecond windows to produce 96 joules per each millisecond and 19.2 joules per each 200 microsecond window.

FIG. 2 also shows that, at 42 milliseconds into the discharge, the discharge pulse length necessary to deliver 19.2 joules per millisecond, exceeds the 200 microsecond window and the laser would be on 100% of the time as the capacitor bank voltage has dropped to 322.6726. This represents less than half of the original voltage of 700V of this exemplary embodiment. The energy remaining in the capacitor bank at that point is 1062 joules. After the desired pulse envelope is completed, for example this 42 millisecond discharge period envelope, or an arbitrary 20 or 40 millisecond envelope, the capacitor bank is allowed to recharge fully during the remainder of second #1, until the next usage time period, e.g., second #2, begins.

FIG. 2 indicates that the pulse length is 45.71 microseconds during the first millisecond. Although the pulse length is 45.71 microseconds during the 200 microsecond window, FIGS. 3A-3C together show that the rod continues to fluoresce after 45.71 microseconds and continuously throughout the 200 microsecond window. FIGS. 3A-3C represent activity of a flashlamp laser configuration during an exemplary 200 microsecond window of, e.g., a 200 microsecond window during the first millisecond time frame of the table of FIG. 2.

More particularly, FIG. 3A shows that current is delivered to power the flashlamp for a time less than the entire 200 microsecond window, in the exemplary embodiment, for about 45.71 microseconds. FIG. 3B shows that, responsive to the delivered current as in FIG. 3A, the flashlamp produces light for a time frame that is about the same as the time current is delivered (FIG. 3A), and which lags slightly with respect to the time frame during which current is provided. FIG. 3C shows the rod fluorescence responsive to the of FIGS. 3A and 3B. Due to the fluorescence decay, the exemplary laser rod, in this case, YAG, fluoresces for about 230 microseconds as in FIG. 3C. As such, energy conservation and a lower coulomb transfer per discharge (pulse) are achieved while providing a power sufficiently high for laser welding because the rod continues to lase during the entire 200 microsecond window although the lamp is only powered for 45.71 microseconds. For example, during the time period between points A and B on each of FIGS. 3A-3C, current is not being provided to the flashlamp, the flashlamp is not delivering light, yet the laser rod fluoresces and the flashlamp laser provides lasing action, that is, a laser beam is produced. While the rod is still fluorescing, the rod is pulsed with energy again, after the 200 microsecond window. When other rod materials with other fluorescence decay times are used, the arbitrary 200 microsecond window may be different or the pulse time during a similar 200 microsecond window, may vary. For example, if vanadate having a 95 microsecond fluorescence decay time, is used, the pulse frequency may be 10 times per millisecond (i.e., a 100 microsecond window).

With respect to the current delivered to the lamp, as indicated by the solid line in FIG. 3A, it should be pointed out that such a step function is provided for illustrative and comparative purposes and that, in practice, the current profile may include a parabolic clipoff, such as indicated by dashed line segment 2. As the operating voltage of the lamp increases, the graph of the current delivered to lamp versus time, approaches the square wave illustrated by the solid line. The voltage of the capacitor bank of the flashlamp determines the maximum lamp current, such as the exemplary 600 amp lamp current shown in FIG. 3A.

Using the exemplary calculations as above and according to the data of the exemplary embodiment of FIG. 2, the coulomb transfer rate during an exemplary period, for example during each pulse of the first millisecond of discharge, equals about (0.000045 seconds)×(600 amps) or 0.027 coulombs transferred per pulse. In this exemplary embodiment, an energy of 96 joules/millisecond is provided to the laser to -provide a laser output power of about 6-10 joules/millisecond depending on the conversion efficiency of the laser. This is sufficient for laser welding of jewelry, for example. Referring again to FIG. 1, this coulomb transfer rate per pulse represents approximately one billion discrete shots. For a 20 millisecond envelope including 5 discrete pulses per millisecond (100 pulse shots), the predicted flashlamp lifetime would therefore be one billion divided by one hundred, which produces about ten million −20 millisecond uses. This represents an improvement of several orders of magnitude over conventional systems which typically include a lifetime of 10,000-500,000 pulses when the flashlamp is continuously powered for 20 millisecond periods. In other embodiments, other coulomb transfer rates of less than 0.05 coulombs per pulse, may be achieved.

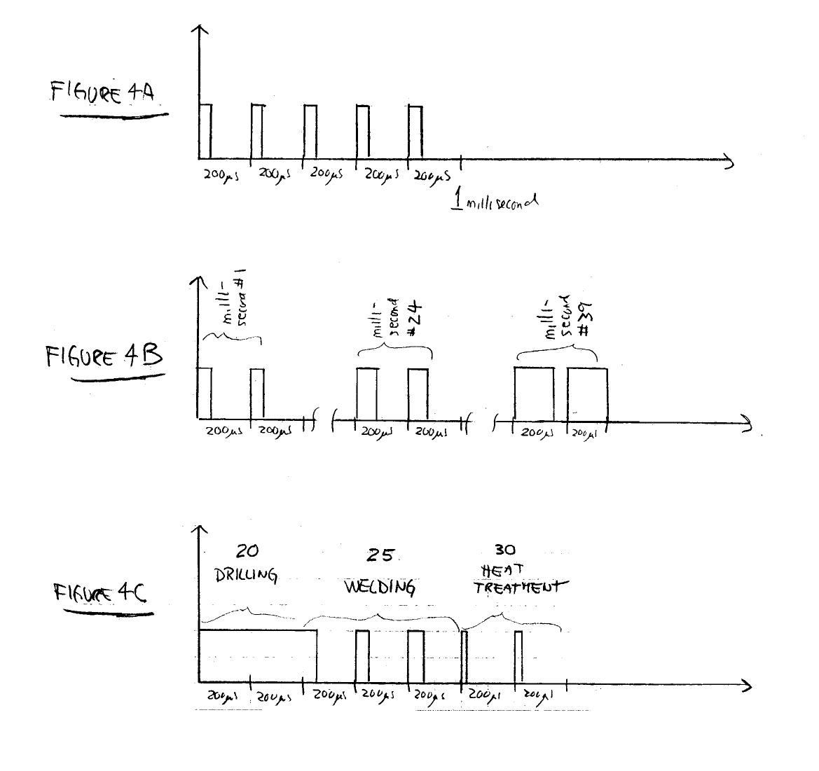

FIG. 4A shows the input power to the lamp during the first millisecond of the exemplary data sequence of FIG. 2, and shows the lamp powered for 45 microseconds per 200 microsecond window. FIG. 4B is a timing diagram showing the time during which power is delivered to the laser along various arbitrary points of the exemplary 42 milliseconds discharge envelope according to the table of FIG. 2. It can be seen that at millisecond #1, that is, 1 millisecond into the discharge or period of operation, the laser is on for approximately 45 microseconds per 200 microsecond window; at 24 milliseconds into the discharge, the lamp is powered for approximately 81 microseconds per 200 microsecond window; and, at 39 milliseconds into the discharge, the lamp is powered for approximately 170 microseconds per 200 microsecond window. This is in order to maintain the same power provided to the laser of 96 joules per millisecond, while the voltage on the capacitor bank drops due to energy being drained from the bank.

Such example is intended to be exemplary only and, in other embodiments, various other laser materials with various other characteristics such as dimensions, energy storage capacity, conversion efficiency and fluorescence decay times, may be used. Furthermore, the capacitor bank voltage may be different in other embodiments. The exemplary time envelopes (e.g., 20, 40, 42 milliseconds per second) during which the laser is intermittently powered, may be varied in other embodiments. Moreover, the division of 1 millisecond into five-200 microsecond windows is intended to be exemplary only, and the providing of 96 joules per millisecond is exemplary and various numbers of discrete pulses per millisecond may be used. The amount of energy required to be delivered during any millisecond or other arbitrarily determined time frame, may be varied in other exemplary embodiments and according to application.

Another aspect of this invention can be seen in FIG. 4C. According to this embodiment, the power desired to be provided by the laser, during each 200 microsecond window of time, is intentionally varied for the laser to perform different operations. This warrants a variation in the pulsing period during the arbitrary time windows irrespective of the voltage drop of the capacitor during operation. During the time in which the laser is desired to be used for drilling 20, the lamp may be powered during the entire arbitrarily identified time period, or for at least 180 microseconds of an exemplary 200 microsecond window. During the laser welding regime 25, the plurality of discrete pulses may be chosen to provide an intermediate power level to the laser sufficient to enable welding, as described in conjunction with the table of FIG. 2. During the heat treatment stage 30, the lamp is powered for a reduced time frame, therefore providing a reduced laser power output. FIG. 4C is intended to be exemplary only and the various time periods used for different purposes may be varied in sequence and duration, according to other exemplary embodiments. According to another exemplary embodiment, not shown, a ramp down mode of operation may be provided. In this ramp down model, the pulse time for each of the five 200 microsecond windows, is decreased by 10 for each successive millisecond. For example, if a ramp down is desired after the 8^{th} millisecond of the table of FIG. 2 (53.9 millisecond pulse), the pulse time during the 9^{th} millisecond may be 53.9−10=43.9 microseconds per 200 microsecond window, the pulse time during the 10^{th} millisecond may be 33.9 microseconds per 200 microsecond window, and so forth.

According to other exemplary embodiments, the pulse times may be varied in different manners to produce different effects. For example, a different amount of power may be delivered during the various milliseconds that combine to form a discharge period. During the discharge period envelope, the power delivered per millisecond, may be chosen to increase or decrease. For example, during the first millisecond a drilling type operation may occur and during the second millisecond, a welding type operation may occur, and so forth. Moreover, the laser may be operated the same throughout the first 20 millisecond envelope of operation, then operated differently during the subsequent 20 millisecond or other time envelope of use.

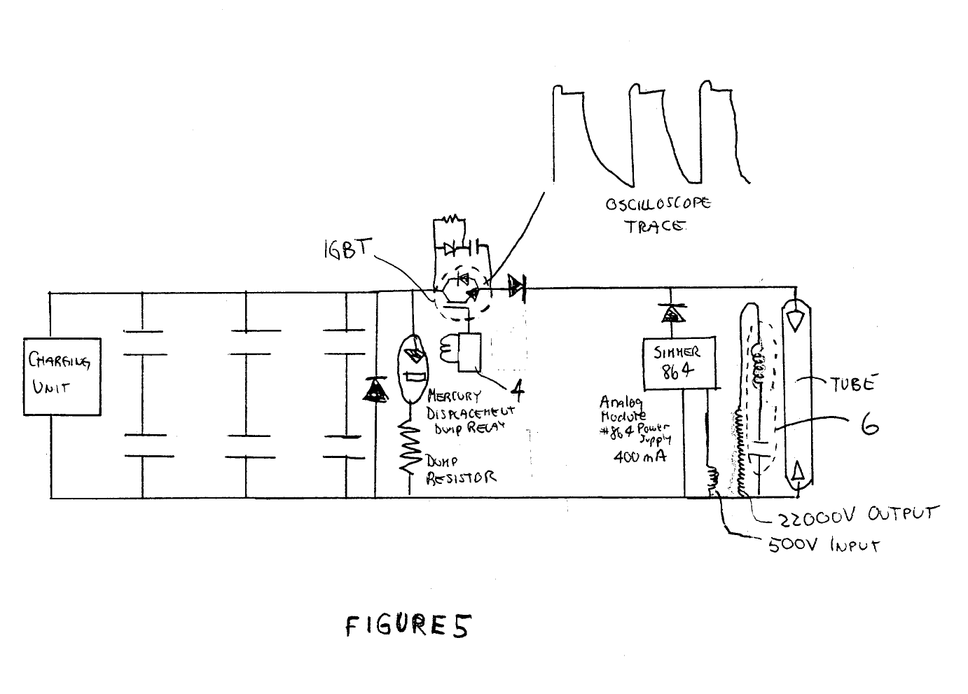

FIG. 5 is an exemplary circuit diagram showing an exemplary flashlamp laser system and indicates system operation for the present invention. In the exemplary circuit diagram of FIG. 5, element 4 may be a microprocessor and radio noise trap 6 may be a 1.5 megahertz filter which behaves according to the expression ½π(LC)^{1/2} in which inductance L may be equal to 360 μh and capacitance C may be equal to 500 pico-farads at 30 kilovolts in a ceramic capacitor according to an exemplary embodiment.

It should be understood that the circuit diagram and the component parameters are intended to be exemplary and illustrative of the present invention and are not presented by means of limitation, and other circuit diagram configurations and component values may be used in other exemplary embodiments.

A general concept of the various embodiments of the present invention, then, is a method and apparatus for operating a flashlamp laser by causing the laser to provide lasing action continuously during a time period (for example during the 200 microsecond window) while powering the flashlamp only during portions (for example, the 45.71 microsecond pulses) of such time period. Current is delivered to the flashlamp during a first time frame such that the flashlamp fluoresces for a second time frame being greater than the first time frame, and current is again delivered to the flashlamp after the exemplary 45.71 microsecond time period but during the 200 microsecond window.

The preceding merely illustrates the principles of the invention. It will thus be appreciated that those skilled in the art will be able to devise various arrangements which, although not explicitly described or shown herein, embody the principles of the invention and are included within its scope and spirit. Furthermore, all examples and conditional language recited herein are principally intended expressly to be only for pedagogical purposes and to aid in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and the functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of the present invention is embodied by the appended claims.

What is claimed is:

1. A method for operating a flashlamp laser comprising:
providing a flashlamp laser including a laser and a flashlamp;
causing said laser to continuously provide a laser beam during a time period while powering said flashlamp only during portions of said time period.

2. The method as in claim 1, wherein said powering comprises delivering current to said flashlamp.

3. The method as in claim 2, wherein said powering comprises delivering current to said flashlamp in a series of discrete pulses.

4. The method as in claim 1, wherein said laser includes a laser rod and said causing includes delivering current to said flashlamp during a first time frame such that said laser rod fluoresces for a second time frame being greater than said first time frame; and
repeating said delivering current to said flashlamp during a first time frame, after said first time frame and during said second time frame.

5. The method as in claim 4, wherein said time period is about 20 milliseconds and said second time frame is about 200 microseconds.

6. The method as in claim 4, wherein said second time frame is about 200 microseconds and said first time frame is about 45 microseconds.

7. The method as in claim 5, wherein said causing includes said laser producing an output power of at least 6 joules/milliseconds.

8. The method as in claim 1, further comprising directing said laser beam to a sample through an optical fiber.

9. The method as in claim 1, further comprising welding by directing said laser beam to a specimen.

10. The method as in claim 1, wherein said powering said flashlamp only during portions of said time period comprises powering said flashlamp in a succession of pulses during said time period, each pulse providing a charge of less than 0.05 coulomb and providing sufficient power over said time period, to enable said laser beam to weld metal.

11. The method as in claim 10, wherein said laser provides an output power of at least 6 joules/millisecond.

12. The method as in claim 10, wherein said laser is a Nd:YAG laser, said time period is about 20 milliseconds, and said causing and said powering enable said Nd:YAG laser to have a lifetime of at least ten million, 20 millisecond uses.

13. The method as in claim 1, in which said laser includes a laser rod, said powering comprises providing power to said flashlamp in discrete pulses, and said causing comprises delivering at least 96 joules per millisecond to said laser rod at a coulomb transfer rate of about 0.027 coulombs per pulse.

14. The method as in claim 1, in which said time period is at least 20 milliseconds and said causing is repeated for a sufficient number of times to weld jewelry.

15. The method as in claim 1, further comprising dividing said time period into a succession of time windows and, during each said time window, delivering current to said flashlamp for a first time period being less than said time window such that said laser produces said laser beam throughout said time window, and increasing said first time period during successive time windows to provide essentially the same output power from said flashlamp, during each of said time windows.

16. An apparatus comprising:
a flashlamp laser including a laser and a flashlamp;
a microprocessor; and
a laser driver,
said laser driver and microprocessor together capable of causing said laser to continuously provide a laser beam throughout a time period during which said flashlamp is powered for only a portion thereof.

17. The apparatus as in claim 16 wherein said laser includes a laser rod formed of Nd:YAG.

18. The apparatus as in claim 16, wherein said microprocessor and said laser driver provide a succession of pulses to said flashlamp during said time period.

19. The apparatus as in claim 16, wherein said flashlamp is formed of one of krypton, argon and xenon, and further comprising an optical transmission medium that delivers said laser beam to a specimen.

20. The apparatus as in claim 16, wherein said laser driver and said microprocessor are together capable of providing a laser beam having power sufficient to weld metal and including a lifetime of at least ten million, 20 millisecond uses.

21. The apparatus as in claim 20, wherein said laser driver and said microprocessor are together capable of causing a succession of pulses to be delivered to said flashlamp, each pulse providing less than 0.05 coulombs to said flashlamp and said succession or pulses providing sufficient power to enable said laser to weld metal.

22. The apparatus as in claim 16, wherein said microprocessor and said laser driver together provide power to said flashlamp during a succession of first time frames that form said time period such that, during each of said successive first time periods, power is provided during a plurality of equal second time frames, said plurality of equal second time frames having an aggregate duration less than said respective first time frame and increasing during successive ones of said first time frames.
